(19) United States
(12) Patent Application Publication
(10) Pub. No.: US 2026/0146574 A1
(43) Pub. Date: May 28, 2026

(54) PISTON HEAD AND PISTON HEAD ASSEMBLY

(71) Applicant: Cummins Power Generation Inc., Minneapolis, MN (US)

(72) Inventors: Ashutosh Shriniwas Chaware, Pune (IN); Harshavardhan Jayajirao Solaskar, Pune (IN); Gaurav Chavan, Pune (IN); Sumit Sanjay Vispute, Pune (IN); Jameson Silvex Mendonca, Pune (IN)

(73) Assignee: Cummins Power Generation Inc., Minneapolis, MN (US)

(21) Appl. No.: 19/446,529

(22) Filed: Jan. 12, 2026

Related U.S. Application Data
(62) Division of application No. 18/990,608, filed on Dec. 20, 2024.

(30) Foreign Application Priority Data
Dec. 21, 2023 (IN) 202341087566

(51) Int. Cl. F02F 3/20; F02F 3/00; F02F 3/28

(52) U.S. Cl. CPC F02F 3/20; F02F 3/0015; F02F 3/28

(57) ABSTRACT

A piston head assembly includes a piston head including an upper portion and a lower portion. The upper portion includes an outer wall and an inner wall disposed radially inward of the outer wall. A cooling gallery is at least partially defined between the outer wall and the inner wall. The extends downward from the upper portion. The lower portion includes an upper surface and a skirt extending from the upper surface. The skirt defines a pin bore centered around a pin bore center axis. A portion of the skirt between the pin bore center axis and a skirt reference axis has a curved vertical profile. The skirt reference axis intersects the pin bore center axis. The piston head assembly includes a plurality of lock plates coupled to the upper portion. Each lock plate extends between the outer wall and the inner wall.

### CROSS-REFERENCE TO RELATED APPLICATIONS

The present application is a divisional of U.S. application Ser. No. 18/990,608, filed on Dec. 20, 2024, which claims priority to Indian Application No. 202341087566, filed Dec. 21, 2023, the entire contents of which are incorporated herein by reference.

### TECHNICAL FIELD

The present application relates generally to a piston head of a piston for use in a combustion cylinder.

### BACKGROUND

Internal combustion engines combust a mixture of fuel (e.g., diesel, gasoline, natural gas, etc.) and air within a combustion chamber. The combustion of the air-fuel mixture causes a piston to move, which in turn generates power (e.g., for moving a vehicle, powering equipment, etc.). The combustion of the air-fuel mixture can increase the temperature of the piston.

### SUMMARY

Various embodiments relate to a piston head. The piston head includes an upper portion that includes an upper wall, an outer wall extending around a periphery of the upper wall, and an inner wall disposed radially inward of the outer wall. A cooling gallery is defined between the outer wall and the inner wall. The piston head further includes a lower portion extending downward from the upper portion. The lower portion includes an upper surface and a skirt extending from the upper surface in a direction away from the upper portion. The skirt defines a pin bore that receives a pin. The pin bore is centered around a pin bore center axis. A portion of the skirt between the pin bore center axis and a skirt reference axis has a vertical profile that is substantially non-linear. The skirt reference axis is orthogonal to the pin bore center axis and parallel to the upper surface.

In some embodiments, the vertical profile of the skirt at the skirt reference axis is substantially linear.

In some embodiments, an average slope of the vertical profile of the portion of the skirt increases in a circumferential direction extending from the skirt reference axis to the pin bore center axis.

In some embodiments, the portion of the skirt extends from an angle greater than 0 degrees relative to the skirt reference axis to an angle relative to the skirt reference axis corresponding to an edge of the pin bore.

In some embodiments, the portion of the skirt includes an upper end proximate the upper surface and a lower end distal from the upper surface. The lower end is disposed closer to the inner wall in a radial direction than the upper end.

In some embodiments, the inner wall extends from the upper wall of the upper portion to the upper surface of the lower portion.

In some embodiments, a gap is defined between the outer wall of the upper portion and the upper surface of the lower portion.

In some embodiments, Vₘᵢₙ=0.03D_{bore}²H_{compression}, where Vₘᵢₙ: a minimum open volume of the cooling gallery, D_{bore}: a diameter of the pin bore, and H_{compression}: a compression height defined as a height extending from the upper wall to the pin bore center axis.

In some embodiments, Vₘₐₓ=0.25D_{bore}²H_{compression}, where Vₘₐₓ: a maximum open volume of the cooling gallery, D_{bore}: a diameter of the pin bore, and H_{compression}: a compression height defined as a height extending from the upper wall to the pin bore center axis.

In some embodiments, the piston head is a single piece piston head forged from steel.

Various embodiments relate to a piston head assembly that includes a piston head. The piston head includes an upper portion that includes an outer wall and an inner wall disposed radially inward of the outer wall. A cooling gallery is at least partially defined between the outer wall and the inner wall. The piston head further includes a lower portion extending downward from the upper portion. The lower portion includes an upper surface and a skirt extending from the upper surface. The skirt defines a pin bore centered around a pin bore center axis. A portion of the skirt between the pin bore center axis and a skirt reference axis has a curved vertical profile. The skirt reference axis intersects the pin bore center axis. The piston head assembly further includes a plurality of lock plates coupled to the upper portion. Each lock plate extends between the outer wall and the inner wall. The cooling gallery is defined between the outer wall, the inner wall, and the plurality of lock plates.

In some embodiments, the lock plates include a first lock plate and a second lock plate. The first lock plate and the second lock plate are parallel to the upper surface of the lower portion.

In some embodiments, each of the lock plates defines an inlet that receives a cooling fluid and communicate the cooling fluid to the cooling gallery. The inlet defines an inlet open area. Each of the lock plates further defines an outlet that receives the cooling fluid from the cooling gallery and releases the cooling fluid out of the cooling gallery. The outlet defines an outlet open area smaller than the inlet open area. The upper surface of the lower portion defines at least one inlet port that receives the cooling fluid and communicates the cooling fluid to the inlet of a corresponding lock plate of the plurality of lock plates, and at least one outlet port that receives the cooling fluid from the outlet of the corresponding lock plate.

In some embodiments, each of the lock plates includes a first edge and a second edge opposite and coaxial with the first edge. The first edge and the second edge extend along a first plate reference axis. Each of the lock plates further includes a tab disposed between the first edge and the second edge at a nonzero angle relative to a second plate reference axis. The second plate reference axis is orthogonal to the first plate reference axis and parallel to the upper surface of the lower portion. The tab engages with the outer wall.

In some embodiments, the nonzero angle extends in a circumferential direction from the second plate reference axis towards the first edge.

In some embodiments, each of the lock plates defines an inlet between the tab and the second edge. The inlet receives cooling fluid and communicates the cooling fluid to the cooling gallery. Each of the lock plates further defines an outlet between the tab and the first edge. The outlet receives the cooling fluid from the cooling gallery and releases the cooling fluid out of the cooling gallery.

In some embodiments, the nonzero angle is greater than 0 degrees and less than or equal to 10 degrees.

In some embodiments, the nonzero angle is 3 degrees.

In some embodiments, the second plate reference axis is parallel to the pin bore center axis.

In some embodiments, the first plate reference axis is parallel to the skirt reference axis.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a perspective cross-sectional view of an example piston head assembly;

FIG. 2 is a front view of the piston head assembly of FIG. 1;

FIG. 3 is a cross-sectional view of the piston head assembly of FIG. 2 taken along plane 3-3 in FIG. 2;

FIG. 4 is a cross-sectional view of the piston head assembly of FIG. 2 taken along plane 4-4 in FIG. 2;

FIG. 5 is a view of Detail A in FIG. 4;

FIG. 6 is a diagram representing vertical profiles of a skirt of a piston head of the piston head assembly according to an example embodiment; and

FIG. 7 is a diagram representing vertical profiles of the skirt at various angles according to another example embodiment.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, apparatuses, and systems for a piston head assembly of an internal combustion engine. The various concepts introduced above and discussed in greater detail below may be implemented in any of a number of ways, as the described concepts are not limited to any particular manner of implementation. Examples of specific implementations and applications are provided primarily for illustrative purposes.

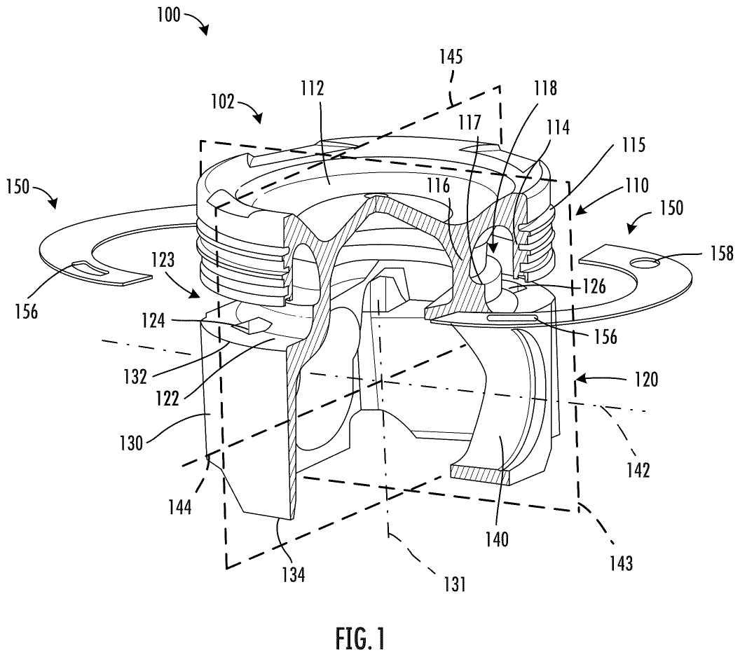

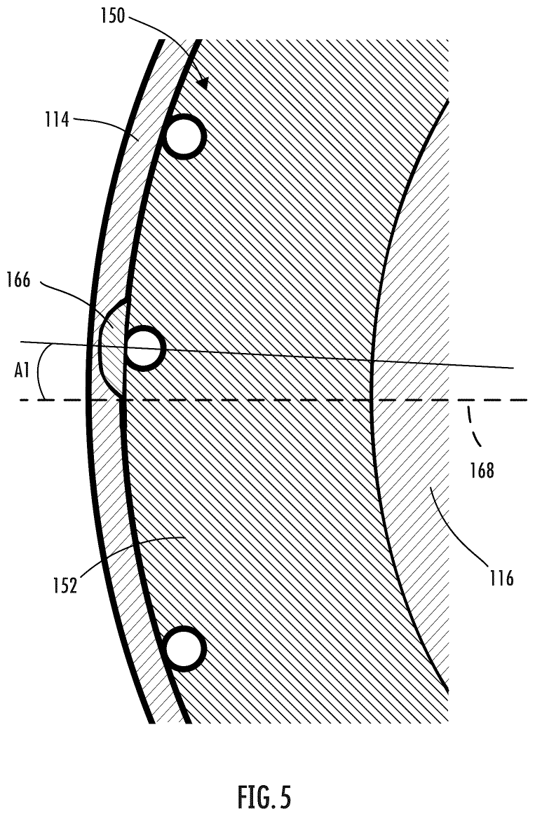

FIGS. 1-5 depict a piston head assembly 100. The piston head assembly 100 can be part of an engine (e.g., an internal combustion engine), such as a spark-ignition engine or a compression-ignition engine. Examples of the engine include a hydrogen engine, a diesel engine, a gasoline engine, a propane engine, a dual-fuel engine, a natural gas engine, etc. The engine is configured to combust at least one fuel (e.g., hydrogen, diesel, gasoline, propane, natural gas, etc., or a combination of fuels) to produce energy that can be utilized by various outputs. For example, the engine can produce energy that is utilized to drive a movement member (e.g., wheel, tread, propeller, impeller, turbine, rotor, etc.) or power a generator. The engine can be implemented in a vehicle (e.g., truck, car, construction vehicle, freight vehicle, commercial vehicle, emergency vehicle, military vehicle, maritime vehicle, etc.).

In some embodiments, the piston head assembly 100 can correspond to a combustion chamber assembly of the engine that is configured to combust fuel. For example, the combustion chamber assembly can include a cylinder (e.g., combustion chamber, etc.) configured to receive the piston head assembly 100. The cylinder can include a cylinder liner or a cylinder wall that at least partially defines an internal volume. The cylinder is configured to receive air from an air intake and fuel from a fuel injector. A mixture of the air and fuel can be combusted within the internal volume of the cylinder.

The piston head assembly 100 includes a piston head 102. The piston head assembly 100 can be a part of a piston assembly. The piston assembly can include a connecting rod that couples to the piston head 102 via a pin (e.g., a piston pin, etc.) received within a pin bore of the piston head 102. The connecting rod can be configured to couple to a crankshaft of the engine. The piston head 102 and the cylinder wall can jointly define the internal volume such that, when the air-fuel mixture is combusted, the piston head 102 is translated axially within the cylinder by the force of the combustion. One or more cylinder rings can be disposed between the piston head 102 and the cylinder liner. The cylinder rings are configured to form a seal between the piston head 102 and the cylinder liner.

FIGS. 1-5 depict the piston head assembly 100 that includes the piston head 102. The piston head 102 comprises an upper portion 110 comprising an upper wall 112, an outer wall 114 extending around a periphery of the upper wall 112, and an inner wall 116 disposed radially inward of the outer wall 114. A cooling gallery 118 is defined between the outer wall 114 and the inner wall 116. The piston head 102 comprises a lower portion 120 extending downward from the upper portion 110. The lower portion 120 comprises an upper surface 122 and a skirt 130 extending from the upper surface 122 in a direction away from the upper portion 110. The skirt 130 defines a pin bore 140 configured to receive a pin. The pin bore 140 is centered around a pin bore center axis 142. A portion of the skirt 130 between the pin bore center axis 142 and a skirt reference axis 144 has a vertical profile that is substantially non-linear. The skirt reference axis 144 is orthogonal to the pin bore center axis 142 and parallel to the upper surface 122.

According to various embodiments, the piston head assembly 100 includes the piston head 102. The piston head 102 includes the upper portion 110 including the outer wall 114 and the inner wall 116 disposed radially inward of the outer wall 114. The cooling gallery 118 is at least partially defined between the outer wall 114 and the inner wall 116. The piston head 102 further includes the lower portion 120 extending downward from the upper portion 110. The lower portion 120 comprises the upper surface 122 and the skirt 130 extending from the upper surface 122. The skirt 130 defines the pin bore 140 centered around the pin bore center axis 142. The portion of the skirt 130 between the pin bore center axis 142 and the skirt reference axis 144 has a curved vertical profile. The skirt reference axis 144 intersects the pin bore center axis 142. The piston head assembly 100 further comprises a plurality of lock plates 150 coupled to the upper portion 110. Each lock plate 150 extends between the outer wall 114 and the inner wall 116. The cooling gallery 118 is defined between the outer wall 114, the inner wall 116, and the plurality of lock plates 150.

The outer wall 114 can extend around the periphery of the upper wall 112 and towards the lower portion 120 in an axial direction. The outer wall 114 of the upper portion 110 can include a plurality of ring grooves 115. Each of the ring grooves 115 is configured to receive a cylinder ring that is configured to form a seal between the piston head 102 and the cylinder liner.

The inner wall 116 can extend from the upper wall 112 of the upper portion 110 to the upper surface 122 of the lower portion 120. A gap 123 can be defined between the outer wall 114 of the upper portion 110 and the upper surface 122 of the lower portion 120. The gap 123 can improve cooling characteristics of the cooling gallery 118 by reducing a surface area the cooling fluid is configured to contact and cool, thereby providing for more efficient and faster cooling. The gap 123 can reduce a total mass of the piston head 102, thereby improving engine characteristics.

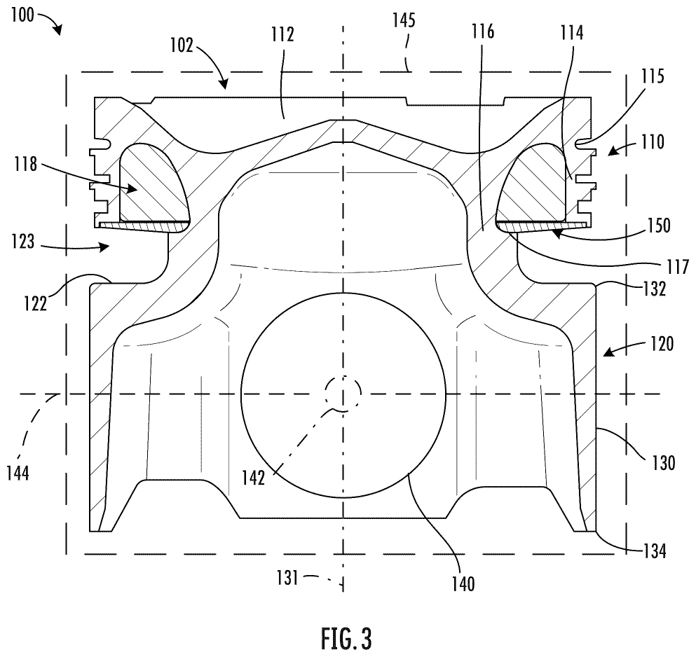

As illustrated in FIG. 3, the upper wall 112 can include a first portion that defines a substantially concave shape. The upper wall 112 can further include a second portion positioned radially inward of the first portion and defining a substantially convex shape.

The portion of the skirt 130 that has the vertical profile that is substantially non-linear can include an upper end proximate the upper surface 122 and a lower end distal from the upper surface 122. In some embodiments, the lower end is disposed closer to the inner wall 116 in a radial direction than the upper end. For example, a lower end radius extending from a skirt center axis 131 of the skirt 130 (i.e., the skirt 130 is centered along the skirt center axis 131) to the lower end is less than an upper end radius extending from the skirt center axis 131 to the upper end. In other embodiments, the upper end is disposed closer to the inner wall 116 in a radial direction than the lower end. For example, the upper end radius is less than the lower end radius. In some embodiments, the portion of the skirt 130 has a vertical profile that is curved (e.g., a curved vertical profile).

In some embodiments, the piston head 102 is a single piece piston head (e.g., manufactured from a single piece of material, etc.). The single piece piston head can simplify a process of manufacturing the piston head 102, provide a relatively high structural strength for the piston head 102, and/or provide a relatively high thermal strength for the piston head 102. In some further embodiments, the piston head 102 that is a single piece piston head is forged from metal. For example, the metal can include steel, aluminum alloy, or the like. In other embodiments, the piston head 102 can be manufactured from a variety of pieces that are coupled together via welding, adhesive, or the like.

As illustrated in FIGS. 1 and 3-5, the piston head assembly 100 includes the piston head 102 and a plurality of lock plates 150 coupled to the upper portion 110 of the piston head 102. Each of the lock plates 150 extends between the outer wall 114 and the inner wall 116. The inner wall 116 can include a shoulder portion 117 configured to receive at least a portion of each of the lock plates 150 and couple each of the lock plates 150 to the inner wall 116. The cooling gallery 118 can be defined between the outer wall 114, the inner wall 116, and the plurality of lock plates 150. The lock plates 150 can be parallel, or substantially parallel, to the upper surface 122 of the lower portion 120.

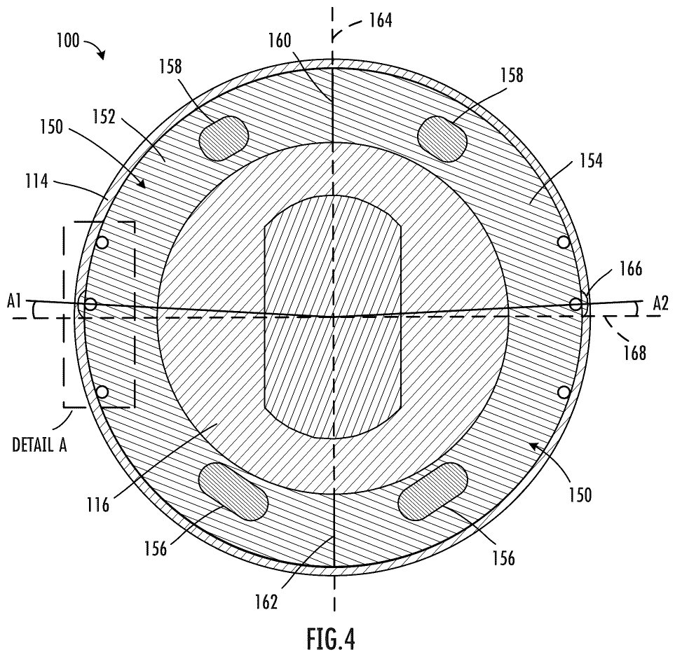

In some embodiments, the lock plates 150 include two lock plates. For example, as illustrated in FIG. 4, the lock plates 150 include a first lock plate 152 and a second lock plate 154. In some embodiments, the first lock plate 152 and the second lock plate 154 have equal mass, volume, and/or surface area. In other embodiments, the first lock plate 152 and the second lock plate 154 have unequal mass, volume, and/or surface area.

In other embodiments (not shown), the lock plates 150 include less than two lock plates (e.g., one lock plate) or more than two lock plates (e.g., three lock plates, four lock plates, seven lock plates, etc.). In some further embodiments, the lock plates 150 have equal mass, volume, and/or surface area. In other further embodiments, the lock plates 150 have unequal mass, volume, and/or surface area.

Each of the lock plates 150 defines an inlet 156 configured to receive a cooling fluid and communicate the cooling fluid to the cooling gallery 118. Each of the lock plates 150 further defines an outlet 158 configured to receive the cooling fluid from the cooling gallery 118 and release the cooling fluid out of the cooling gallery 118.

In some embodiments, the inlet 156 can define an inlet open area that is greater than an outlet open area of the outlet 158, thereby allowing the cooling gallery 118 to retain enough of the cooling fluid for sufficient cooling of the piston head 102, and, particularly, at least portions of the upper wall 112, the outer wall 114 (including the ring grooves 115), and/or the inner wall 116. In other embodiments, the inlet open area can be equal to, or approximately equal to, the outlet open area. In yet other embodiments, the inlet open area can be less than the outlet open area.

As illustrated in FIG. 4, each of the lock plates 150 can include a first edge 160 and a second edge 162 opposite the first edge 160. The first edge 160 and the second edge 162 can be coaxial. The first edge 160 and the second edge 162 can extend along a first plate reference axis 164. The first plate reference axis 164 can be parallel to the skirt reference axis 144. In some embodiments, the skirt reference axis 144 can be offset from the pin bore center axis 142. As shown in FIG. 4, the skirt reference axis 144 intersects the pin bore center axis 142. For example, the skirt reference axis 144 can be orthogonal to the pin bore center axis 142.

Each of the lock plates 150 can include a tab 166 disposed between the first edge 160 and the second edge 162. The tab 166 is configured to engage with a tab groove of the outer wall 114 via snap-fit (e.g., friction-fit, etc.), thereby coupling a corresponding lock plate of the lock plates 150 to the outer wall 114. The tab groove of the outer wall 114 can be defined along an inner surface of the outer wall 114, where the ring grooves 115 are defined along an outer surface of the outer wall 114 opposite the inner surface of the outer wall 114. A combination of the tab 166 and the shoulder portion 117 of the inner wall 116 can couple the corresponding lock plate to the upper portion 110.

The tab 166 can be disposed between the first edge 160 and the second edge 162 at a first nonzero angle A1 relative to a second plate reference axis 168. The second plate reference axis 168 can be orthogonal to the first plate reference axis 164 and parallel to the upper surface 122 of the lower portion 120. The second plate reference axis 168 can be parallel to the pin bore center axis 142. The first nonzero angle A1 can extend in a circumferential direction from the second plate reference axis 168 toward the first edge 160. The tab groove of the outer wall 114 that is configured to receive the tab 166 can be disposed along the inner surface of the outer wall 114 at an angle relative to the second plate reference axis 168 that is equal to, or approximately equal to, the first nonzero angle A1.

In some embodiments, as illustrated in FIG. 4, in which the lock plates 150 include the first lock plate 152 and the second lock plate 154, the tab 166 of the first lock plate 152 can be disposed between the first edge 160 and the second edge 162 at the first nonzero angle A1 relative to the second plate reference axis 168, and the tab 166 of the second lock plate 154 can be disposed between the first edge 160 and the second edge 162 at a second nonzero angle A2 relative to the second plate reference axis 168. The second nonzero angle A2 can extend in a circumferential direction from the second plate reference axis 168 toward the first edge 160. The first nonzero angle A1 and the second nonzero angle A2 allow the first lock plate 152 and the second lock plate 154 to be coupled to the upper portion 110 only in a correct orientation relative to the inlet 156 and the outlet 158, thereby ensuring the inlets 156 of both the first lock plate 152 and the second lock plate 154 are located in correct positions relative to injections of a coolant fluid (discussed in further detail herein).

The first nonzero angle A1 and the second nonzero angle A2 are angled so as to prevent the first lock plate 152 and the second lock plate 154 from being assembled in incorrect orientations. The incorrect orientations include the first lock plate 152 and the second lock plate 154 being located in opposite positions relative to each other (e.g., flipped relative to the first plate reference axis 164). Given that the inner grooves of the outer wall 114, which are configured to receive the tabs 166 of the first lock plate 152 and the second lock plate 154, are respectively angled relative to the second plate reference axis 168 at the first nonzero angle A1 and the second nonzero angle A2 based on the correct orientation of the first lock plate 152 and the second lock plate 154, having the first lock plate 152 and the second lock plate 154 in opposite positions while the tabs 166 are received in their non-corresponding inner grooves results in (i) the first lock plate 152 and the second lock plate 154 at least partially overlapping and (ii) the inlet 156 of at least one of the first lock plate 152 or the second lock plate 154 being in an incorrect position relative to the coolant injection.

Other incorrect orientations include using two of the first lock plate 152, rather than one of the first lock plate 152 and one of the second lock plate 154, or using two of the second lock plate 154, rather than one of the first lock plate 152 and one of the second lock plate 154. Both of these incorrect orientations would result in (i) overlapping lock plates (e.g., the two the first lock plates 152 at least partially overlapping, the two the second lock plates 154 at least partially overlapping, etc.) and (ii) the inlet 156 of at least one of the first lock plate 152 or the second lock plate 154 being in an incorrect position relative to the coolant injection.

In some embodiments, the first nonzero angle A1 and the second nonzero angle A2 are equal or approximately equal. In other embodiments, the first nonzero angle A1 and the second nonzero angle A2 are unequal. In some embodiments, at least one of the first nonzero angle A1 or the second nonzero angle A2 is greater than 0 degrees and less than or equal to 10 degrees, and, preferably, equal to, or approximately equal to, 3 degrees. In other embodiments, at least one of the first nonzero angle A1 or the second nonzero angle A2 is greater than 0 degrees and less than 90 degrees.

In some embodiments, as illustrated in FIG. 4, at least one of the first nonzero angle A1 or the second nonzero angle A2 extends in a circumferential direction from the second plate reference axis 168 towards the first edge 160. In other embodiments (not shown), at least one of the first nonzero angle A1 or the second nonzero angle A2 extends in the circumferential direction from the second plate reference axis 168 towards the second edge 162.

In some embodiments, as illustrated in FIG. 4, the inlet 156 is defined between the tab 166 and the second edge 162, and the outlet 158 is defined between the tab 166 and the first edge 160. In other embodiments (not shown), the inlet 156 is defined between the tab 166 and the first edge 160, and the outlet 158 is defined between the tab 166 and the second edge 162.

The engine can include a coolant injection system positioned proximate the combustion chamber assembly. The coolant injection system can include a nozzle for supplying a fluid (e.g., oil, coolant, lubricant, etc.). The nozzle can extend towards the piston head 102 such that the nozzle supplies the coolant to the piston head 102.

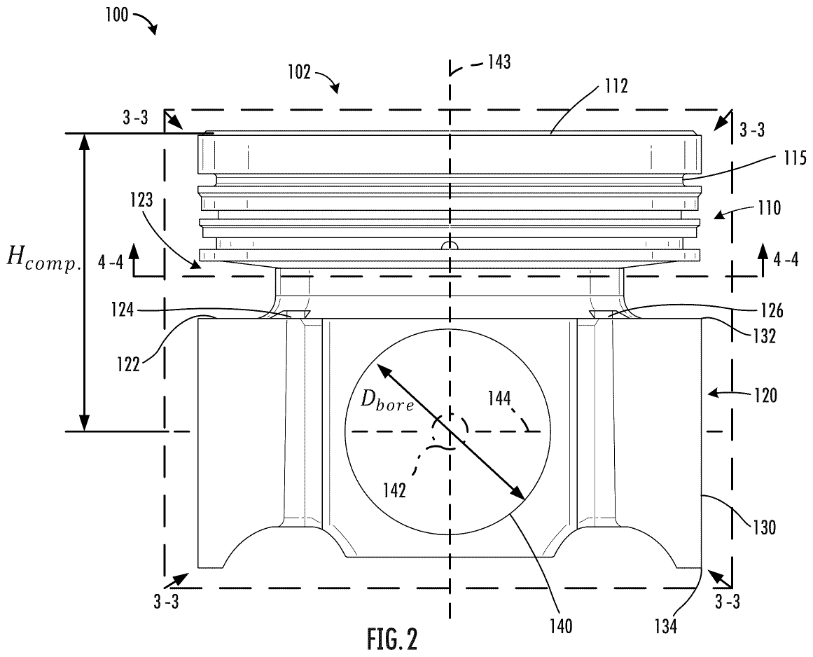

As illustrated in FIGS. 1 and 2, the upper surface 122 of the lower portion 120 can define at least one inlet port 124 configured to receive the cooling fluid via the nozzle of the coolant injection system and communicate the cooling fluid to the inlet 156 of a corresponding lock plate of the lock plates 150. The upper surface 122 of the lower portion 120 can further define at least one outlet port 126 configured to receive the cooling fluid from the outlet 158 of the corresponding lock plate and release the received cooling fluid downstream of the outlet port 126.

An open volume of the cooling gallery 118 can be defined by the outer wall 114, the inner wall 116, and the plurality of lock plates 150. A minimum open volume of the cooling gallery 118 (Vₘᵢₙ) can be determined based on Equation (1), as shown below.

$${V}_{min} = 0 \text{.03} {D}_{b o r e}^{2} {H}_{compression} \qquad ( 1 )$$

The minimum open volume (Vₘᵢₙ) determined based on Equation (1) is dependent on a diameter of the pin bore 140 (D_{bore}) and a compression height (H_{compression} or H_{comp.}) defined as a height extending from the upper wall 112 to the pin bore center axis 142. The minimum open volume (Vₘᵢₙ) determined based on Equation (1) can be the minimum open volume of the cooling gallery 118 that allows for adequate cooling of the piston head 102 via the cooling fluid within the cooling gallery 118 and/or simplifies a manufacturing process of the piston head 102.

A maximum open volume of the cooling gallery 118 (Vₘₐₓ) can be determined based on Equation (2), as shown below.

$${V}_{max} = 0 \text{.25} {D}_{b o r e}^{2} {H}_{compression} \qquad ( 2 )$$

The maximum open volume (Vₘₐₓ) determined based on Equation (2) is dependent on the diameter of the pin bore 140 (D_{bore}) and the compression height (H_{comp.}) defined as the height extending from the upper wall 112 to the pin bore center axis 142. The maximum open volume (Vₘₐₓ) determined based on Equation (2) can be the maximum open volume of the cooling gallery 118 that allows for adequate structural strength of the piston head 102, allows for adequate thermal strength of the piston head 102 against thermal stresses, and/or simplifies the manufacturing process of the piston head 102.

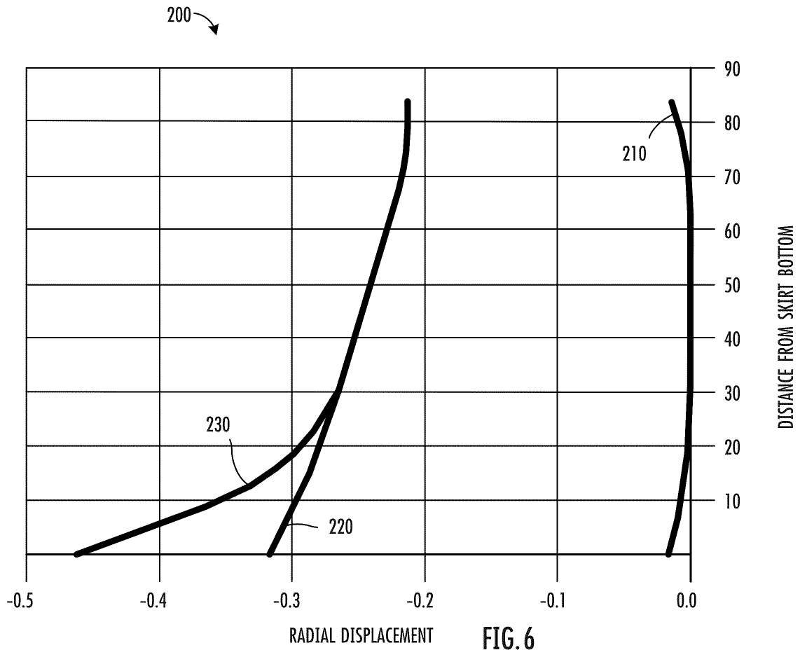

FIG. 6 illustrates a diagram of vertical profiles 200 of skirts (e.g., the skirt 130, etc.) that includes radial displacement relative to the skirt 130 at the skirt reference axis 144 in the x-axis and distance from a bottom of the skirt (e.g., the second edge 162 of the skirt 130, etc.) in the y-axis. Zero in the radial displacement can correspond to the radius of the skirt 130 at the skirt reference axis 144. It is to be appreciated that the values provided in the x- and y-axes of FIG. 6 are for exemplary purposes only, such that values of the radial displacement and the distance from the bottom of the skirt are not limited to the values presented, and such that values other than the values presented (i.e., within the range presented, outside of the range presented, etc.) can be included.

As illustrated in FIGS. 1-3, the skirt 130 can include an upper edge 132 proximate the upper surface 122 and a lower edge 134 distal from the upper surface 122. The vertical profiles 200, illustrated in FIG. 6, include a first vertical skirt profile 210 at a skirt reference plane 145 that is orthogonal to the pin bore center axis 142, where the skirt reference axis 144 extends along the skirt reference plane 145. The first vertical skirt profile 210 can be substantially linear.

In some embodiments, at least a portion of the first vertical skirt profile 210 is curved. In some examples, a radius of the lower edge 134 extending from the skirt center axis 131 along the skirt reference plane 145 and radius of the upper edge 132 extending from the skirt center axis 131 along the skirt reference plane 145 are both less than a radius of the skirt 130 between the upper edge 132 and the lower edge 134 extending from the skirt center axis 131 along the skirt reference plane 145. In other examples, the radius of the lower edge 134 along the skirt reference plane 145 can be less than the radius of the upper edge 132 along the skirt reference plane 145.

In other embodiments, the first vertical skirt profile 210 is flat or substantially flat. For example, the radius of the lower edge 134 along the skirt reference plane 145 can be equal to, or approximately equal to, the radius of the upper edge 132 along the skirt reference plane 145 and the radius the skirt 130 between the upper edge 132 and the lower edge 134 along the skirt reference plane 145.

The vertical profiles 200 include a second vertical skirt profile 220 at a pin bore plane 143 that is orthogonal to the skirt reference axis 144 and the skirt reference plane 145, where the pin bore center axis 142 extends along the pin bore plane 143. The second vertical skirt profile 220 can be substantially linear. In some embodiments, at least a portion the second vertical skirt profile 220 is curved. In other embodiments, the second vertical skirt profile 220 is flat or substantially flat.

The vertical profiles 200 include a third vertical skirt profile 230 at the pin bore plane 143. The third vertical skirt profile 230 can be substantially non-linear, as illustrated by the radial displacement in FIG. 6 between a distance of 0 and 30 from the skirt bottom. The substantially non-linear profile of the third vertical skirt profile 230 can prevent or minimize accidental contact between the skirt bottom (e.g., the second edge 162 of the skirt 130) and the cylinder liner. In particular, accidental contact can be avoided during thermo-mechanical deformation, thereby minimizing damage to the piston head 102 and the cylinder liner.

In some embodiments, the substantially linear profile of the second vertical skirt profile 220 includes one substantially constant slope throughout an entirety of the vertical profile or throughout a majority of the vertical profile. In other embodiments, the substantially linear profile of the second vertical skirt profile 220 includes two or more slopes along the vertical profile. In some further embodiments, both the substantially linear profile of the second vertical skirt profile 220 and the substantially non-linear profile of the third vertical skirt profile 230 include two or more slopes along their respective vertical profiles. In these embodiments, the substantially linear vertical profile of the second vertical skirt profile 220 and the substantially non-linear profile of the third vertical skirt profile 230 have differing degrees of freedom between their respective two or more slopes (i.e., degrees of freedom (e.g., maximum difference, etc.) between a first slope and a second slope of the two or more slopes, etc.). More particularly, the two or more slopes corresponding to the substantially non-linear profile (e.g., the third vertical skirt profile 230) have greater degrees of freedom than the two or more slopes corresponding to the substantially linear profile (e.g., the second vertical skirt profile 220).

In some embodiments, at least a portion the third vertical skirt profile 230 is curved. In further embodiments, a curvature of the third vertical skirt profile 230 can increase (e.g., radial displacement increases) as the distance from the skirt bottom (e.g., the second edge 162 of the skirt 130) decreases. In other embodiments, the third vertical skirt profile 230 is flat or substantially flat.

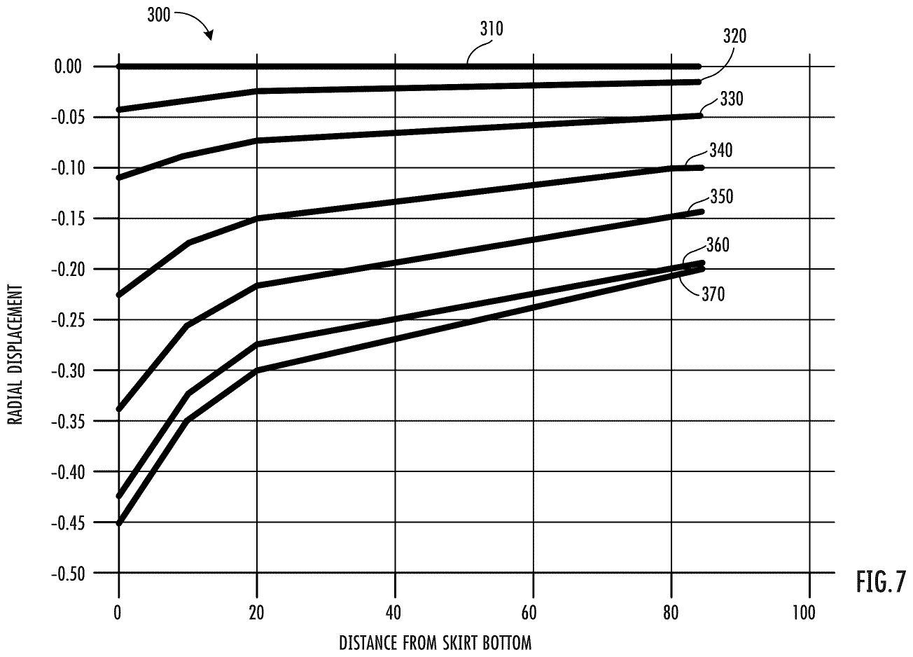

FIG. 7 illustrates a diagram of vertical profiles 300 of the skirt 130 at various angles relative to the skirt reference plane 145. The diagram of the vertical profiles 300 includes radial displacement relative to the skirt 130 at the skirt reference axis 144 in the y-axis and distance from a bottom of the skirt (e.g., the second edge 162 of the skirt 130, etc.) in the x-axis. Zero in the radial displacement can correspond to the radius of the skirt 130 at the skirt reference axis 144. It is to be appreciated that the values provided in the x- and y-axes of FIG. 7 are for exemplary purposes only, such that values of the radial displacement and the distance from the bottom of the skirt are not limited to the values presented, and such that values other than the values presented can be included.

The vertical profiles 300 include a first angle vertical skirt profile 310 at a first angle relative to skirt reference plane 145. The first angle can be equal to, or approximately equal to, 0 degrees, such that the first angle vertical skirt profile 310 is at the skirt reference plane 145. In some embodiments, as illustrated in FIG. 7, the first angle vertical skirt profile 310 is flat or substantially flat. In other embodiments, at least a portion of the first angle vertical skirt profile 310 is curved.

The vertical profiles 300 further includes a second angle vertical skirt profile 320 at a second angle relative to the skirt reference plane 145, a third angle vertical skirt profile 330 at a third angle relative to the skirt reference plane 145, a fourth angle vertical skirt profile 340 at a fourth angle relative to the skirt reference plane 145, a fifth angle vertical skirt profile 350 at a fifth angle relative to the skirt reference plane 145, a sixth angle vertical skirt profile 360 at a sixth angle relative to the skirt reference plane 145, and a seventh angle vertical skirt profile 370 at a seventh angle relative to the skirt reference plane 145. The second angle can be equal to, or approximately equal to, 15 degrees, the third angle can be equal to, or approximately equal to, 30 degrees, the fourth angle can be equal to, or approximately equal to, 45 degrees, the fifth angle can be equal to, or approximately equal to, 60 degrees, the sixth angle can be equal to, or approximately equal to, 75 degrees, and the seventh angle can be equal to, or approximately equal to, 90 degrees (i.e., at the pin bore center axis 142).

As illustrated in FIG. 7, at least some of the second angle vertical skirt profile 320, the third angle vertical skirt profile 330, the fourth angle vertical skirt profile 340, the fifth angle vertical skirt profile 350, the sixth angle vertical skirt profile 360, and the seventh angle vertical skirt profile 370 are substantially non-linear.

An average slope of the vertical profile of the portion of the skirt 130 that has a vertical profile that is substantially non-linear can increase in a circumferential direction extending from the skirt reference plane 145 to the pin bore plane 143 or extending from the skirt reference plane 145 to the pin bore center axis 142. More specifically, an average slope of the radial displacement over distance from the skirt bottom for the vertical profiles 310-370 (i.e., the first angle vertical skirt profile 310, the second angle vertical skirt profile 320, the third angle vertical skirt profile 330, the fourth angle vertical skirt profile 340, the fifth angle vertical skirt profile 350, the sixth angle vertical skirt profile 360, and the seventh angle vertical skirt profile 370) can increase as the angle relative to the skirt reference plane 145 increases.

For example, the average slope of the seventh angle vertical skirt profile 370 can be greater than an average slope of the sixth angle vertical skirt profile 360, the average slope of the sixth angle vertical skirt profile 360 can be greater than an average slope of the fifth angle vertical skirt profile 350, the average slope of the fifth angle vertical skirt profile 350 can be greater than an average slope of the fourth angle vertical skirt profile 340, the fourth angle vertical skirt profile 340 can be greater than an average slope of the third angle vertical skirt profile 330, the average slope of the third angle vertical skirt profile 330 can be greater than an average slope of the second angle vertical skirt profile 320, and/or the average slope of the second angle vertical skirt profile 320 can be greater than an average slope of the first angle vertical skirt profile 310.

In some embodiments, the piston head 102 does not physically include at least one vertical profile of the vertical profiles 310-370. In these embodiments, the at least one vertical profile of the vertical profiles 310-370 that is not physically included in the piston head 102 is utilized for modeling and/or designing the piston head 102 by assisting in generation of other vertical profiles of the vertical profiles 310-370 via interpolation. In some examples, the at least one vertical profile of the vertical profiles 310-370 that is not physically included in the piston head 102 includes the seventh angle vertical skirt profile 370 at the pin bore plane 143. In some examples, the at least one vertical profile of the vertical profiles 310-370 that is not physically included in the piston head 102 includes the sixth angle vertical skirt profile 360 and the seventh angle vertical skirt profile 370.

In some embodiments, the piston head 102 does not include the substantially non-linear vertical profile proximate the pin bore 140. For example, the portion of the skirt 130 that has the vertical profile that is substantially non-linear can extend at an angle greater than 0 degrees relative to the skirt reference plane 145 (or the skirt reference axis 144) to an angle relative to the skirt reference plane 145 (or the skirt reference axis 144) corresponding to an edge of the pin bore 140.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

Unless otherwise indicated, all numbers expressing quantities of properties, parameters, conditions, and so forth, used in the specification and claims are to be understood as being modified in all instances by the terms “about” or “approximately.” Accordingly, unless indicated to the contrary, the numerical parameters set forth in the following specification and attached claims are approximations. Any numerical parameter should at least be construed in light of the number reported significant digits and by applying ordinary rounding techniques. The terms “about” or “approximately” when used before a numerical designation, e.g., temperature, time, amount, and concentration including range, indicates approximations which may vary by (+) or (−) 10%, 5% or 1%.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

In some instances, terms such as “coupled to” in connection with fluidic systems can mean that two components or objects have a pathway formed between the two components or objects in which a fluid, such as air, treatment fluid, an air-treatment fluid mixture, exhaust, hydrocarbon fluid, an air-hydrocarbon fluid mixture, may flow, either with or without intervening components or objects. Examples of such couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) can include or exclude intermediate values within the range of values (e.g., W1 to W2 can include only W1 and W2, etc.).

What is claimed is:

1. A piston head assembly, comprising:
a piston head comprising:
an upper portion comprising:
an outer wall, and
an inner wall disposed radially inward of the outer wall,
wherein a cooling gallery is at least partially defined between the outer wall and the inner wall; and
a lower portion extending downward from the upper portion, the lower portion comprising:
an upper surface, and
a skirt extending from the upper surface, the skirt defining a pin bore centered around a pin bore center axis, a portion of the skirt between the pin bore center axis and a skirt reference axis having a curved vertical profile, the skirt reference axis intersecting the pin bore center axis; and
a plurality of lock plates coupled to the upper portion, each lock plate extending between the outer wall and the inner wall, wherein the cooling gallery is defined between the outer wall, the inner wall, and the plurality of lock plates.

2. The piston head assembly of claim 1, wherein the lock plates comprises a first lock plate and a second lock plate, the first lock plate and the second lock plate being parallel to the upper surface of the lower portion.

3. The piston head assembly of claim 1, wherein:
each of the lock plates defines:
an inlet configured to receive a cooling fluid and communicate the cooling fluid to the cooling gallery, the inlet defining an inlet open area, and
an outlet configured to receive the cooling fluid from the cooling gallery and release the cooling fluid out of the cooling gallery, the outlet defining an outlet open area smaller than the inlet open area; and
the upper surface of the lower portion defines:
at least one inlet port configured to receive the cooling fluid and communicate the cooling fluid to the inlet of a corresponding lock plate of the plurality of lock plates, and
at least one outlet port configured to receive the cooling fluid from the outlet of the corresponding lock plate.

4. The piston head assembly of claim 1, wherein each of the lock plates comprises:
a first edge;
a second edge opposite and coaxial with the first edge, the first edge and the second edge extending along a first plate reference axis; and
a tab disposed between the first edge and the second edge at a nonzero angle relative to a second plate reference axis, the second plate reference axis being orthogonal to the first plate reference axis and parallel to the upper surface of the lower portion, the tab configured to engage with the outer wall.

5. The piston head assembly of claim 4, wherein the nonzero angle extends in a circumferential direction from the second plate reference axis towards the first edge.

6. The piston head assembly of claim 4, wherein each of the lock plates defines:
an inlet between the tab and the second edge, the inlet configured to receive cooling fluid and communicate the cooling fluid to the cooling gallery; and
an outlet between the tab and the first edge, the outlet configured to receive the cooling fluid from the cooling gallery and release the cooling fluid out of the cooling gallery.

7. The piston head assembly of claim 4, wherein the nonzero angle is greater than 0 degrees and less than or equal to 10 degrees.

8. The piston head assembly of claim 7, wherein the nonzero angle is 3 degrees.

9. The piston head assembly of claim 4, wherein the second plate reference axis is parallel to the pin bore center axis.

10. The piston head assembly of claim 4, wherein the first plate reference axis is parallel to the skirt reference axis.
